(19) United States
(12) Patent Application Publication
(10) Pub. No.: US 2022/0187789 A1
(43) Pub. Date: Jun. 16, 2022

(54) EQUIPMENT FAILURE DIAGNOSIS APPARATUS, EQUIPMENT FAILURE DIAGNOSIS METHOD, SMART FACTORY SYSTEM AND APPLICATION AGENT

(71) Applicant: LG Display Co., Ltd., Seoul (KR)

(72) Inventors: Jungwon RYU, Seoul (KR); Hankyeol LEE, Seoul (KR); EuiYeol OH, Seoul (KR); JongJin PARK, Gyeonggi-do (KR); ByeongHyeon NA, Seoul (KR)

(73) Assignee: LG Display Co., Ltd., Seoul (KR)

(21) Appl. No.: 17/338,187

(22) Filed: Jun. 3, 2021

(30) Foreign Application Priority Data
Dec. 10, 2020 (KR) 10-2020-0172726

(51) Int. Cl. G05B 19/4063; G05B 19/418; G06N 20/00

(52) U.S. Cl. CPC G05B 19/4063; G05B 19/418; G05B 2219/37433; G05B 2219/34294; G05B 2219/36537; G06N 20/00

(57) ABSTRACT

An equipment failure diagnosis apparatus, an equipment failure diagnosis method, a smart factory system, and an application agent configured to generate a virtual abnormal signal based on a normal signal data stored in the database, determine whether an equipment signal is an abnormal signal based on a virtual abnormal signal data for the virtual abnormal signal, and output a determination result information. Accordingly, the present disclosure can quickly and accurately diagnose a failure of equipment in a factory, even under conditions where labeling data is not present or insufficient.

### CROSS-REFERENCE TO RELATED APPLICATION

This application claims the benefit and priority from Korean Patent Application No. 10-2020-0172726, filed on Dec. 10, 2020, which is hereby incorporated by reference in its entirety.

### BACKGROUND

### Field of the Disclosure

The present disclosure relates to equipment failure diagnosis apparatus, equipment failure diagnosis method, smart factory system and application agent.

### Description of the Background

In the existing plant operation, the occurrence of equipment failure in the plant is monitored based on the management personnel. Such management manpower-based equipment abnormal motoring method has a problem in that equipment failure cannot be detected quickly and immediately, and the accuracy of failure detection is also inferior.

Accordingly, various attempts are being made in the industry to diagnose equipment failure using artificial intelligence that is in the spotlight these days. However, it is still not possible to develop a technology capable of accurately and effectively diagnosing equipment failures using artificial intelligence

### SUMMARY

The present disclosure provides an equipment failure diagnosis apparatus, an equipment failure diagnosis method, a smart factory system, and an application agent capable of accurately and quickly diagnosing equipment failure using artificial intelligence.

The present disclosure provides an equipment failure diagnosis apparatus, an equipment failure diagnosis method, a smart factory system, and an application agent applicable to various industrial groups.

The present disclosure provides an equipment failure diagnosis apparatus, an equipment failure diagnosis method, a smart factory system, and an application agent capable of diagnosing equipment failure even if there is no or insufficient labeling data necessary for determining or learning equipment failure.

The present disclosure provides an equipment failure diagnosis apparatus, an equipment failure diagnosis method, a smart factory system, and an application agent capable of diagnosing equipment failure in a factory in a display industrial site with no or insufficient labeling data.

The present disclosure provides an equipment failure diagnosis apparatus, an equipment failure diagnosis method, a smart factory system, and an application agent capable of accurately diagnosing equipment failure while building a database using the virtual abnormal signal generated by generating a virtual abnormal signal in a situation where labeling data is not present or insufficient.

The present disclosure provide an equipment failure diagnosis apparatus, an equipment failure diagnosis method, a smart factory system, and an application agent capable of quickly and accurately diagnosing equipment failure based on an acoustic signal.

The present disclosure provides an equipment failure diagnosis apparatus, an equipment failure diagnosis method, a smart factory system, and an application agent capable of developing an artificial intelligence network model based on virtual abnormal signal generation when developing an artificial intelligence network model through unlabeled data.

The present disclosure provides an equipment failure diagnosis apparatus, an equipment failure diagnosis method, a smart factory system, and an application agent having an acoustic collection environment robust to noise so that accurate equipment failure diagnosis is possible based on an acoustic signal.

The present disclosure provides an equipment failure diagnosis apparatus, an equipment failure diagnosis method, a smart factory system, and an application agent capable of performing management functions such as maintenance of an artificial intelligence network.

According to aspects of the present disclosure, there are an equipment failure diagnosis apparatus, an equipment failure diagnosis method, a smart factory system, and an application agent configured to generate a virtual abnormal signal based on a normal signal data stored in the database, determine whether an equipment signal generated from the target equipment is an abnormal signal based on a virtual abnormal signal data for the virtual abnormal signal, and output a determination result information. Accordingly, the present disclosure can quickly and accurately diagnose a failure of equipment in a factory, even under conditions where labeling data is not present or insufficient.

According to one aspect of the present disclosure, there is an equipment failure diagnosis apparatus including: a virtual abnormal signal generator configured to generate a virtual abnormal signal based on a normal signal data stored in a database, and to store a virtual abnormal signal data for the virtual abnormal signal in the database; an equipment signal acquirer configured to obtain an equipment signal generated from a target equipment; and an abnormal signal determiner configured to determine whether the equipment signal is an abnormal signal based on the virtual abnormal signal data, and to output determination result information.

The equipment signal acquirer may include an acoustic signal collector for collecting acoustic signals through a plurality of microphone devices, and a preprocessor for obtaining the equipment signal by comparing the acoustic signals collected by the acoustic signal collector.

The plurality of microphone devices may include at least one first microphone device installed toward the target equipment, and at least one second microphone device installed toward a direction different from the first microphone device without facing the target equipment.

The acoustic signal collector may be configured to collect a first acoustic signal through the at least one first microphone device, and to collect a second acoustic signal through the at least one second microphone device.

The preprocessor may be configured to obtain the equipment signal based on the first acoustic signal and the second acoustic signal. The preprocessor may be configured to obtain the equipment signal by removing external noise that does not occur in the target equipment based on a result of comparing the first acoustic signal and the second acoustic signal.

When an abnormal signal data is not stored in the database as labeling data for determining the abnormal signal, the virtual abnormal signal generator may be configured to generate the virtual abnormal signal based on the normal signal data. When the abnormal signal data for abnormal signals less than a preset number is stored in the database as labeling data for determining the abnormal signal, the virtual abnormal signal generator may be configured to generate the virtual abnormal signal based on the normal signal data and the abnormal signal data.

The virtual abnormal signal generator may be configured to generate, as the virtual abnormal signal, a signal having a frequency range different from a frequency range of the normal signal.

The virtual abnormal signal generator may be configured to remove external noise from the equipment signal for generating the virtual abnormal signal and generate the remaining signal as the virtual abnormal signal.

The virtual abnormal signal generator may compress the virtual abnormal signal data and store the compressed virtual abnormal signal data in the database.

The abnormal signal determiner may be configured to calculate first detection rate corresponding to a probability that the equipment signal is an abnormal signal based on the normal signal data and the virtual abnormal signal data. The abnormal signal determiner may be configured to compare the first detection rate with a first threshold value. When the first detection rate is less than the first threshold value, the abnormal signal determiner may be configured to output normal determination result information indicating that the equipment signal is a normal signal, label a data on the equipment signal as normal signal data, and store the data labeled as the normal signal data in the database. When the first detection rate is equal to or greater than the first threshold value, the abnormal signal determiner may be configured to output an abnormality determination result information indicating that the equipment signal is an abnormal signal based on an artificial intelligence archive, label a data on the equipment signal as abnormal signal data, and store the data labeled as the abnormal signal data in the database.

The equipment failure diagnosis apparatus may further include an artificial intelligence network manager for storing and managing the artificial intelligence archive.

When it is determined by the abnormal signal determiner that the first detection rate is equal to or greater than the first threshold value, the artificial intelligence network manager may be configured to determine whether the equipment signal is a new type of abnormal signal using an existing artificial intelligence network model in the artificial intelligence archive.

When it is determined that the equipment signal is an abnormal signal of an existing type, the artificial intelligence network manager may be configured to control the abnormal signal determiner to output the abnormality determination result information indicating that the equipment signal is an abnormal signal, label the data on the equipment signal as abnormal signal data, and store the data labeled as the abnormal signal data in the database.

When it is determined that the equipment signal is a new type of abnormal signal, the artificial intelligence network manager may be configured to add a new artificial intelligence network model to update the artificial intelligence archive, control the abnormal signal determiner to output the abnormality determination result information indicating that the equipment signal is an abnormal signal, label the data on the equipment signal as abnormal signal data, and store the data labeled as abnormal signal data in the database.

The artificial intelligence network manager may be configured to calculate a second detection rate for the equipment signal by using the existing artificial intelligence network model in the artificial intelligence archive, and compare the second detection rate with a preset second threshold value.

When the second detection rate is equal to or greater than the second threshold value, the artificial intelligence network manager may be configured to determine that an abnormal signal corresponding to the equipment signal is a known abnormal signal. When the second detection rate is less than the second threshold value, the artificial intelligence network manager may be configured to determine that the abnormal signal corresponding to the equipment signal is a new type of abnormal signal, additionally configure a new artificial intelligence network model, perform machine learning on the new artificial intelligence network model, and update the artificial intelligence archive so that the new artificial intelligence network model is included in the artificial intelligence archive.

The target equipment may be equipment for manufacturing a display panel, and the equipment signal may be an acoustic signal generated from the target equipment.

According to another aspect of the present disclosure, there is an equipment failure diagnosis method comprising: generating a virtual abnormal signal based on a normal signal data stored in a database; obtaining an equipment signal generated from a target equipment; and determining whether the equipment signal is an abnormal signal based on the virtual abnormal signal, and outputting determination result information.

The obtaining of the equipment signal may include: collecting acoustic signals through a plurality of microphone devices; and comparing the collected acoustic signals to detect external noise that does not occur in the target equipment, and removing the external noise from the collected acoustic signals to obtain the equipment signal.

The collecting of the acoustic signals may include: collecting a first acoustic signal through at least one first microphone device installed toward the target equipment; and collecting a second acoustic signal through at least one second microphone device installed toward a different direction from the first microphone device.

The generating of the virtual abnormal signal may be executed when an abnormal signal data is not stored in the database or an abnormal signal data for less than a specific number of abnormal signals is stored in the database.

The operation of generating the virtual abnormal signal may be the operation of generating a signal having a frequency range different from a frequency range of the normal signal as the virtual abnormal signal.

The determining whether the equipment signal is the abnormal signal may include: calculating first detection rate corresponding to a probability that the equipment signal is an abnormal signal based on the normal signal data and the virtual abnormal signal data; comparing the first detection rate with a first threshold value; when the first detection rate is less than the first threshold value, outputting a normal determination result information indicating that the equipment signal is a normal signal, labeling a data on the equipment signal as normal signal data, and storing the data labeled as the normal signal data in the database; and when the first detection rate is equal to or greater than the first threshold value, outputting an abnormality determination result information indicating that the equipment signal is an abnormal signal based on an artificial intelligence archive, labeling a data on the equipment signal as abnormal signal data, and storing the data labeled as the abnormal signal data in the database.

The determining whether the equipment signal is the abnormal signal may include: when the first detection rate is equal to or greater than the first threshold value, determining whether the equipment signal is a new type of abnormal signal using an existing artificial intelligence network model in the artificial intelligence archive; when the equipment signal is an abnormal signal of an existing type, outputting the abnormality determination result information indicating that the equipment signal is an abnormal signal, labeling the data on the equipment signal as abnormal signal data, and storing the data labeled as the abnormal signal data in the database; and when the equipment signal is a new type of abnormal signal, adding a new artificial intelligence network model to update the artificial intelligence archive, outputting the abnormality determination result information indicating that the equipment signal is an abnormal signal, labeling the data on the equipment signal as abnormal signal data, and storing the data labeled as abnormal signal data in the database.

According to another aspect of the present disclosure, there is an application agent stored and executed in a storage medium in a computer in order to execute a method for diagnosing equipment failure, the method comprising: generating a virtual abnormal signal based on a normal signal data stored in a database; obtaining an equipment signal generated from a target equipment through at least one microphone device; and determining whether the equipment signal is an abnormal signal based on the virtual abnormal signal and outputting determination result information.

According to another aspect of the present disclosure, there is a smart factory system including: a first sensor installed around the first equipment and configured to sense and output acoustic signals; a second sensor installed around the second equipment and configured to sense and output acoustic signals; and an equipment failure diagnosis apparatus configured to diagnose whether each of the first equipment and the second equipment has a failure, wherein the equipment failure diagnosis apparatus is configured to: extract the first equipment signal generated by the first equipment from the acoustic signal output from the first sensor, extract a second equipment signal generated by the second equipment from the acoustic signal output from the second sensor, determine whether each of the first equipment signal and the second equipment signal is an abnormal signal by referring to the artificial intelligence network model in the artificial intelligence archive, and database, and output the determination result information, and add a new artificial intelligence network model to the artificial intelligence archive, or label a data for each of the first equipment signal and the second equipment signal as normal signal data or abnormal signal data and store the labeled data in the database.

The first sensor may include at least one first microphone device installed toward the first equipment, and at least one second microphone device installed toward a different direction from the first microphone device without facing the first equipment. The second sensor may include at least one third microphone device installed toward the second equipment, and at least one fourth microphone device installed toward a direction different from the third microphone device without facing the second equipment.

The equipment failure diagnosis apparatus may collect a first acoustic signal through at least one first microphone device in the first sensor, and may collect a second acoustic signal through at least one second microphone device in the first sensor. The equipment failure diagnosis apparatus may acquire a first equipment signal generated by the first equipment based on the first acoustic signal and the second acoustic signal. The equipment failure diagnosis apparatus may obtain a first equipment signal by comparing the first acoustic signal and the second acoustic signal and removing external noise that is not generated in the first equipment according to the comparison. The equipment failure diagnosis apparatus may determine whether the first equipment signal is an abnormal signal by referring to the artificial intelligence network model in the artificial intelligence archive and the database, and output the determination result information.

The equipment failure diagnosis apparatus may collect a third acoustic signal through at least one third microphone device in the second sensor, and may collect a fourth acoustic signal through at least one fourth microphone device in the second sensor. The equipment failure diagnosis apparatus may acquire a second equipment signal generated by the second equipment based on the third acoustic signal and the fourth acoustic signal. The equipment failure diagnosis apparatus may obtain a second equipment signal by comparing the third acoustic signal and the fourth acoustic signal and removing external noise that is not generated in the second equipment according to the comparison. The equipment failure diagnosis apparatus may determine whether the second equipment signal is an abnormal signal by referring to the artificial intelligence network model in the artificial intelligence archive and the database, and output the determination result information.

The first equipment and the second equipment may be equipment for manufacturing a display panel, and the first equipment signal and the second equipment signal may be acoustic signals generated from each of the first equipment and the second equipment.

The equipment failure diagnosis apparatus may include an IoT (Internet of Things) communication module for IoT-based networking with the first sensor and the second sensor.

According to the aspects of the present disclosure, it is possible to provide an equipment failure diagnosis apparatus, an equipment failure diagnosis method, a smart factory system, and an application agent capable of accurately and quickly diagnosing equipment failure using artificial intelligence.

According to the aspects of the present disclosure, it is possible to provide an equipment failure diagnosis apparatus, an equipment failure diagnosis method, a smart factory system, and an application agent applicable to various industrial groups.

According to the aspects of the present disclosure, it is possible to provide an equipment failure diagnosis apparatus, an equipment failure diagnosis method, a smart factory system, and an application agent capable of diagnosing equipment failure even if there is no or insufficient labeling data necessary for determining or learning equipment failure.

According to the aspects of the present disclosure, it is possible to provide an equipment failure diagnosis apparatus, an equipment failure diagnosis method, a smart factory system, and an application agent capable of diagnosing equipment failure in a factory in a display industrial site with no or insufficient labeling data.

According to the aspects of the present disclosure, it is possible to provide an equipment failure diagnosis apparatus, an equipment failure diagnosis method, a smart factory system, and an application agent capable of accurately diagnosing equipment failure while building a database using the virtual abnormal signal generated by generating a virtual abnormal signal in a situation where labeling data is not present or insufficient.

According to the aspects of the present disclosure, it is possible to provide an equipment failure diagnosis apparatus, an equipment failure diagnosis method, a smart factory system, and an application agent capable of quickly and accurately diagnosing equipment failure based on an acoustic signal.

According to the aspects of the present disclosure, it is possible to provide an equipment failure diagnosis apparatus, an equipment failure diagnosis method, a smart factory system, and an application agent capable of developing an artificial intelligence network model based on virtual abnormal signal generation when developing an artificial intelligence network model through unlabeled data.

According to the aspects of the present disclosure, it is possible to provide an equipment failure diagnosis apparatus, an equipment failure diagnosis method, a smart factory system, and an application agent having an acoustic collection environment robust to noise so that accurate equipment failure diagnosis is possible based on an acoustic signal.

According to the aspects of the present disclosure, it is possible to provide an equipment failure diagnosis apparatus, an equipment failure diagnosis method, a smart factory system, and an application agent capable of performing management functions such as maintenance of an artificial intelligence network.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating a smart factory system according to aspects of the present disclosure;

FIG. 2 is a diagram illustrating sensors of a smart factory system according to aspects of the present disclosure;

FIG. 3 is a block diagram of an equipment failure diagnosis apparatus according to aspects of the present disclosure;

FIG. 4 is a diagram schematically illustrating an equipment failure diagnosis process according to aspects of the present disclosure;

FIG. 5 is a diagram illustrating an equipment signal acquirer of an equipment failure diagnosis apparatus according to aspects of the present disclosure;

FIG. 6 is a diagram for explaining a signal separation function of the equipment failure diagnosis apparatus according to aspects of the present disclosure;

FIG. 7 is a histogram showing characteristics of a normal signal and an abnormal signal distinguished by the equipment failure diagnosis apparatus according to aspects of the present disclosure;

FIG. 8 is a diagram illustrating an artificial intelligence network management function of an equipment failure diagnosis apparatus according to aspects of the present disclosure;

FIG. 9 is a diagram conceptually illustrating an additional configuration for a new artificial intelligence network model when managing an artificial intelligence network of the equipment failure diagnosis apparatus according to aspects of the present disclosure; and

FIG. 10 is a flowchart of an equipment failure diagnosis method according to aspects of the present disclosure.

### DETAILED DESCRIPTION

In the following description of examples or aspects of the present disclosure, reference will be made to the accompanying drawings in which it is shown by way of illustration specific examples or aspects that can be implemented, and in which the same reference numerals and signs can be used to designate the same or like components even when they are shown in different accompanying drawings from one another. Further, in the following description of examples or aspects of the present disclosure, detailed descriptions of well-known functions and components incorporated herein will be omitted when it is determined that the description may make the subject matter in some aspects of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

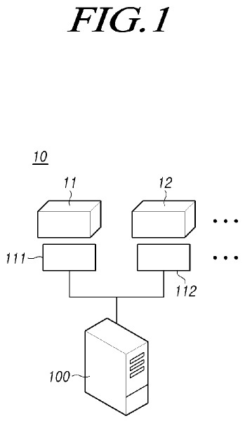

FIG. 1 is a diagram illustrating a smart factory system 10 according to aspects of the present disclosure.

Referring to FIG. 1, a smart factory system 10 according to aspects of the present disclosure is a system that monitors equipment failure by monitoring the state of a plurality of equipment 11 and 12 in the factory. The smart factory system 10 according to the aspects of the present disclosure includes an equipment failure diagnosis device 100 for diagnosing a failure of each of the plurality of equipment 11 and 12. The smart factory system 10 according to the aspects of the present disclosure may further include a plurality of sensors 111 and 112 installed around the plurality of equipment 11 and 12. The equipment failure diagnosis apparatus 100 according to the aspects of the present disclosure may diagnose a failure of each of the plurality of equipment 11 and 12 using a plurality of sensors 111 and 112. Here, the failure of the equipment 11 and 12 is also referred to as a fault or breakdown.

In the smart factory system 10 exemplarily illustrated in FIG. 1, two equipment 11 and 12 are present, but are not limited thereto, and there may be one equipment or three or more equipment. The smart factory system 10 exemplarily illustrated in FIG. 1 includes a first sensor 111 and a second sensor 112, but is not limited thereto, and there is one sensor or three or more sensors.

Referring to FIG. 1, the first equipment 11 and the second equipment 12 are equipment used for various purposes in a factory, and may generate any type of acoustic signal during operation.

The acoustic signal may be generated by various factors related to the equipment 11 and 12. For example, the acoustic signal may be one of the electronic sound of the electronic devices constituting the equipment, the vibration sound of mechanical parts (e.g., motors, belts, etc.) that make up the equipment, the fricative sound between the mechanical parts that make up the equipment and the acoustic signals generated by chemical reactions in the equipment. For another example, the acoustic signal may be an acoustic signal in which two or more of the electronic sound of the electronic devices constituting the equipment, the vibration sound of mechanical parts that make up the equipment, the fricative sound between the mechanical parts (e.g., motors, belts, etc.) that make up the equipment and the acoustic signals generated by chemical reactions in the equipment are mixed.

In the following, the acoustic signal generated from the first equipment 11 is referred to as a first equipment signal, and the acoustic signal generated from the second equipment 12 is referred to as a second equipment signal. Here, the acoustic signal is also referred to as a sound signal.

When the first equipment 11 and the second equipment 12 are in a normal state, the first equipment signal and the second equipment signal may have predicted or known signal characteristics, or may have predetermined or regular signal characteristics. Below, when the first equipment 11 and the second equipment 12 are in a normal state, the first equipment signal and the second equipment signal are referred to as normal signals.

However, when the first equipment 11 and the second equipment 12 are in an abnormal state (failure state), the first equipment signal and the second equipment signal generated from the first equipment 11 and the second equipment 12 have signal characteristics different from those of the normal signal. That is, when the first equipment 11 and the second equipment 12 are in an abnormal state (failure state), the first equipment signal and the second equipment signal generated from the first equipment 11 and the second equipment 12 may have unpredictable or unknown signal characteristics, or have unspecified or irregular types of signal characteristics. Below, when the first equipment 11 and the second equipment 12 are in an abnormal state (failure state), the first equipment signal and the second equipment signal are referred to as abnormal signals.

For example, in aspects of the present disclosure, the first equipment 11 and the second equipment 12 may be equipment for manufacturing a display panel. In the aspects of the present disclosure, the first equipment 11 and the second equipment 12 may be the same type of equipment or different types of equipment.

When both the first equipment 11 and the second equipment 12 are in a normal state, the first equipment signal generated from the first equipment 11 and the second equipment signal generated from the second equipment 12 may be the same or different.

When both the first equipment 11 and the second equipment 12 are in an abnormal state (failure state), the first equipment signal generated from the first equipment 11 and the second equipment signal generated from the second equipment 12 may be the same or different.

Referring to FIG. 1, the first sensor 111 is installed around the first equipment 11 and may sense and output acoustic signals at the installed location. The second sensor 112 is installed around the second equipment 12 and may sense and output acoustic signals at the installed location.

Referring to FIG. 1, the equipment failure diagnosis apparatus 100 may obtain the first equipment signal of the first equipment 11 by using the acoustic signals output from the first sensor 111, and obtain the second equipment signal of the second equipment 12 by using the acoustic signals output from the second sensor 112. The equipment failure diagnosis apparatus 100 may determine the presence or absence of an abnormality in each of the first equipment signal and the second equipment signal obtained by using an artificial intelligence (AI) function. The equipment failure diagnosis apparatus 100 may diagnose the failure of each of the first equipment and the second equipment, based on a result of determining whether each of the first equipment signal and the second equipment signal is abnormal. In other words, the equipment failure diagnosis apparatus 100 may determine whether each of the first equipment signal and the second equipment signal is an abnormal signal by using the artificial intelligence function. The equipment failure diagnosis apparatus 100 may diagnose the failure of each of the first equipment 11 and the second equipment 12 according to a determination result of whether each of the first equipment signal and the second equipment signal is an abnormal signal.

In more detail, the equipment failure diagnosis apparatus 100 may extract a first equipment signal generated by the first equipment 11 from acoustic signals output from the first sensor 111, and extract a second equipment signal generated by the second equipment 12 from acoustic signals output from the second sensor 112. The equipment failure diagnosis apparatus 100 may determine whether each of the first equipment signal and the second equipment signal is an abnormal signal by referring to the database and the artificial intelligence network model in the artificial intelligence archive stored in advance, and output the determination result information. The equipment failure diagnosis apparatus 100 may add a new artificial intelligence network model to the artificial intelligence archive, or label the data for each of the first equipment signal and the second equipment signal as normal signal data or abnormal signal data, and store the labeled data in the database.

The artificial intelligence (AI) archive mentioned above may be a file that collects various types of artificial intelligence-related data for easy retrieval, and may contain one or more artificial intelligence network models.

The artificial intelligence network model may have a form in which several neurons, which are basic computing units, are connected by a weighted link. The weighted link may be weighted so as to adapt to a given environment.

The artificial intelligence network model may also be referred to as an artificial neural network. The artificial intelligence network model may include various models such as SOM (Self-Organizing Map), RNN (Recurrent Neural Network), or CNN (Convolutional Neural Network).

Referring to FIG. 1, a plurality of sensors 111 and 112 and an equipment failure diagnosis apparatus 100 may configure a sensor network based on the IoT (Internet of Things). The plurality of sensors 111 and 112 and the equipment failure diagnosis apparatus 100 may communicate with each other through a communication infrastructure such as an access point, or may communicate with each other without a communication infrastructure.

The equipment failure diagnosis apparatus 100 according to aspects of the present disclosure may be implemented as a server (computer) communicating with a plurality of sensors 111 and 112. The equipment failure diagnosis apparatus 100 may be located together with the equipment 11 and 12 in the factory. Alternatively, the equipment failure diagnosis apparatus 100 may be located outside the factory and may be located in a space geographically separated from the equipment 11 and 12 in the factory.

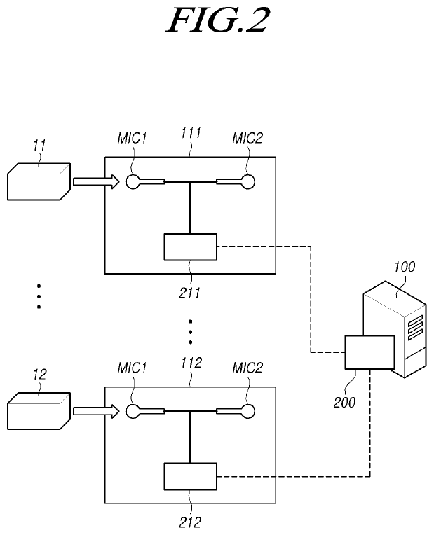

FIG. 2 is a diagram illustrating sensors 111 and 112 of a smart factory system 10 according to aspects of the present disclosure.

Referring to FIG. 2, the first sensor 111 may include at least one first microphone device MIC1 installed toward the first equipment 11 and at least one second microphone device MIC2 installed toward a direction different from the first microphone device MIC1 without facing the first equipment 11.

The first sensor 111 may further include a processing device 211. The processing device 211 may receive first acoustic signals output from at least one first microphone device MIC1 and second acoustic signals output from at least one second microphone device MIC2. The processing device 211 may transmit the received first and second acoustic signals to the equipment failure diagnosis device 100.

Referring to FIG. 2, the second sensor 112 may include at least one first microphone device MIC1 installed toward the second equipment 12 and at least one second microphone device MIC2 installed toward a direction different from the first microphone device MIC1 without facing the second equipment 12.

The second sensor 112 may further include a processing device 212. The processing device 212 may receive first acoustic signals output from at least one first microphone device MIC1 and second acoustic signals output from at least one second microphone device MIC2. The processing apparatus 212 may transmit the received first and second acoustic signals to the equipment failure diagnosis apparatus 100.

Referring to FIG. 2, the equipment failure diagnosis apparatus 100 may collect a first acoustic signal through at least one first microphone device MIC1 in the first sensor 111, and may collect a second acoustic signal through at least one second microphone device MIC2 in the first sensor 111. The equipment failure diagnosis apparatus 100 may acquire a first equipment signal generated by the first equipment 11 based on the first acoustic signal and the second acoustic signal. The equipment failure diagnosis apparatus 100 may obtain a first equipment signal including only the acoustic signal generated by the first equipment 11 by comparing the first acoustic signal and the second acoustic signal. Here, the first equipment signal may be a signal from which external noise not generated from the first equipment 11 has been removed. More specifically, the equipment failure diagnosis apparatus 100 may extract external noise that is not generated in the first equipment 11 from the first acoustic signal and the second acoustic signal through comparison of the first acoustic signal and the second acoustic signal. The equipment failure diagnosis apparatus 100 may remove external noise from the first acoustic signal and the second acoustic signal, and obtain a signal from which the external noise is removed from the first acoustic signal and the second acoustic signal as the first equipment signal. Accordingly, the equipment failure diagnosis apparatus 100 may exactly obtain the first equipment signal including only an acoustic signal generated by the first equipment 11.

Referring to FIG. 2, the equipment failure diagnosis apparatus 100 may collect a first acoustic signal through at least one first microphone device MIC1 in the second sensor 112, and may collect a second acoustic signal through at least one second microphone device MIC2 in the second sensor 112. The equipment failure diagnosis apparatus 100 may acquire a second equipment signal generated by the second equipment 12 based on the first acoustic signal and the second acoustic signal. The equipment failure diagnosis apparatus 100 may obtain a second equipment signal including only the acoustic signal generated by the second equipment 12 by comparing the first acoustic signal and the second acoustic signal. Here, the second equipment signal may be a signal from which external noise not generated from the second equipment 12 has been removed. More specifically, the equipment failure diagnosis apparatus 100 may extract external noise that is not generated in the second equipment 12 from the first acoustic signal and the second acoustic signal through comparison of the first acoustic signal and the second acoustic signal. The equipment failure diagnosis apparatus 100 may remove external noise from the first acoustic signal and the second acoustic signal, and obtain a signal from which the external noise is removed from the first acoustic signal and the second acoustic signal as the second equipment signal. Accordingly, the equipment failure diagnosis apparatus 100 may exactly obtain the second equipment signal including only an acoustic signal generated by the second equipment 12.

Referring to FIG. 2, the equipment failure diagnosis apparatus 100 may include a communication module 200 for IoT-based networking with the first and second sensors 111 and 112. The first sensor 111, the second sensor 112, and the communication module 200 may communicate in a wired manner or wirelessly.

Hereinafter, when the first equipment 11 is target equipment for failure diagnosis, the equipment failure diagnosis apparatus 100 for diagnosing a failure of the first equipment 11 based on an equipment signal and an operation method thereof will be described. In the following, the first equipment 11 is also described as the target equipment 11.

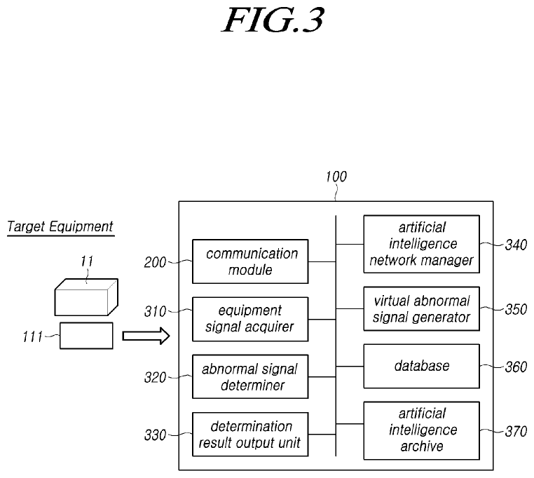

FIG. 3 is a block diagram of an equipment failure diagnosis apparatus 100 according to aspects of the present disclosure.

Referring to FIG. 3, the equipment failure diagnosis apparatus 100 according to aspects of the present disclosure may include an equipment signal acquirer 310, an abnormal signal determiner 320, a determination result output unit 330, an artificial intelligence network manager 340, a virtual abnormal signal generator 350, and a database 360, and an artificial intelligence archive 370, and the like.

The virtual abnormal signal generator 350 may generate a virtual abnormal signal based on the normal signal data stored in the database 360 and store virtual abnormal signal data for the virtual abnormal signal in the database 360.

For example, the virtual abnormal signal generator 350 may generate a signal having a frequency range different from the frequency range of the normal signal as the virtual abnormal signal based on the normal signal data. For another example, the virtual abnormal signal generator 350 may generate a signal remaining after removing external noise from an equipment signal for generating a virtual abnormal signal as a virtual abnormal signal.

After generating the virtual abnormal signal, the virtual abnormal signal generator 350 may compress virtual abnormal signal data, which is data for the generated virtual abnormal signal, and store the compressed virtual abnormal signal data in the database 360. The virtual abnormal signal generator 350 compresses the virtual abnormal signal data and stores it in the database 360, thereby reducing the amount of data stored in the database 360.

When the abnormal signal data is not stored in the database 360, or abnormal signal data for abnormal signals less than a preset number is stored in the database 360, the virtual abnormal signal generator 350 may generate a virtual abnormal signal based on the normal signal data.

The database 360 may store normal signal data, virtual abnormal signal data, and a small amount of real data (real normal signal data or real abnormal signal data).

The equipment signal acquirer 310 may acquire equipment signals generated by the target equipment 11. The abnormal signal determiner 320 may determine whether the equipment signal is an abnormal signal based on the virtual abnormal signal data and output the determination result information.

For example, the target equipment 11 may be equipment for manufacturing a display panel, and the equipment signal may be an acoustic signal generated from the target equipment 11.

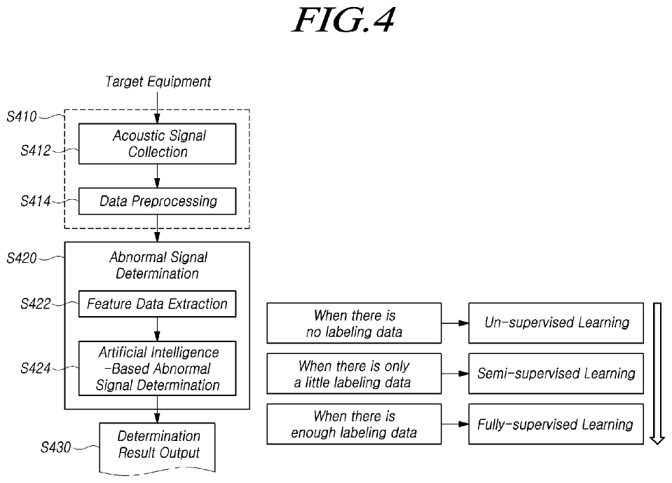

FIG. 4 is a diagram schematically illustrating an equipment failure diagnosis process according to aspects of the present disclosure.

Referring to FIG. 4, a process for diagnosing equipment failure according to aspects of the present disclosure may include an equipment signal acquisition step S410, an abnormal signal determination step S420, and a determination result output step S430. In the equipment signal acquisition step S410, the equipment failure diagnosis apparatus 100 may obtain an equipment signal of the target equipment 11. In the abnormal signal determination step S420, the equipment failure diagnosis apparatus 100 may determine whether the acquired equipment signal is an abnormal signal. In the determination result output step S430, the equipment failure diagnosis apparatus 100 may output determination result information.

The equipment signal acquisition step S410 may include an acoustic signal collection step S412 and an external noise removal step S414. In the acoustic signal collection step S412, the equipment failure diagnosis apparatus 100 may collect acoustic signals through the first sensor 111 installed around the target equipment 11. In the external noise removal step S414, the equipment failure diagnosis apparatus 100 may obtain an equipment signal by removing external noise from the acoustic signals through data preprocessing on the collected acoustic signals.

The abnormal signal determination step S420 may include a feature data extraction step S422 and an artificial intelligence-based abnormal signal determination step S424. In the feature data extraction step S422, the equipment failure diagnosis apparatus 100 may extract feature data from the equipment signal obtained in the equipment signal acquisition step S410. In the artificial intelligence-based abnormal signal determination step S424, the equipment failure diagnosis apparatus 100 may determine whether the equipment signal is an abnormal signal by using artificial intelligence based on the extracted feature data.

In the determination result output step S430, the equipment failure diagnosis apparatus 100 may output the determination result information in the abnormal signal determination step S420. For example, the determination result information may include equipment identification information, abnormality information, abnormal phenomenon characteristic information, date and time information, and the like.

The equipment failure diagnosis apparatus 100 may input the extracted feature data as an input value of the artificial intelligence network model for each of the artificial intelligence network models included in the artificial intelligence archive. Thereafter, the equipment failure diagnosis apparatus 100 may obtain a result output from each artificial intelligence network model as an abnormal signal or not.

In order for the equipment failure diagnosis apparatus 100 to obtain more accurate results (results of abnormal signals) through artificial intelligence network models, the artificial intelligence network model needs to be further deepened through more learning.

Here, in the aspects of the present disclosure, learning may also be referred to as machine learning or deep learning. And learning may be a concept that further includes data mining, which means a process of discovering useful correlations hidden among a lot of data, extracting actionable information in the future, and using it for decision-making.

For example, the machine learning algorithm may include a decision tree algorithm, a Bayesian network, a support vector machine (SVM), and an artificial neural network.

Referring to FIG. 4, the learning mode of the equipment failure diagnosis apparatus 100 may include unsupervised learning, semi-supervised learning, and fully-supervised learning.

Fully-supervised learning may be a learning method in which information is first taught to the equipment failure diagnosis apparatus 100. For example, fully-supervised learning is a learning method that includes a learning process in which any equipment signal data is given and this equipment signal data is notified as abnormal signal data or normal signal data. According to the fully-supervised learning, the equipment failure diagnosis apparatus 100 may distinguish between an abnormal signal and a normal signal based on a sufficiently large amount of labeling data as a result of pre-learning.

Unsupervised learning may be a learning method performed by the equipment failure diagnosis apparatus 100 by itself without the learning process as in fully-supervised learning. In the case of unsupervised learning, the equipment failure diagnosis apparatus 100 does not have any labeling data as a result of learning in advance. Accordingly, the equipment failure diagnosis apparatus 100 may perform self-learning (unsupervised learning) of a method of recognizing that any equipment signal data is abnormal signal data and any other equipment signal data is normal signal data. Therefore, unsupervised learning requires high computational capability of the equipment failure diagnosis apparatus 100.

Semi-supervised learning may be a learning method that the equipment failure diagnosis apparatus 100 can perform when the equipment failure diagnosis apparatus 100 does not have enough labeling data but has some labeling data. Through semi-supervised learning, the equipment failure diagnosis apparatus 100 may distinguish an abnormal signal from a normal signal by using some labeling data.

The apparatus 100 for diagnosing equipment failure according to aspects of the present disclosure may initially perform unsupervised learning. The equipment failure diagnosis apparatus 100 starts generating labeling data through unsupervised learning, and begins to accumulate labeling data little by little. When the accumulation amount of labeling data reaches the first level or higher through unsupervised learning, the equipment failure diagnosis apparatus 100 may perform semi-supervised learning. The equipment failure diagnosis apparatus 100 may accumulate more labeling data by performing semi-supervised learning. When the accumulation amount of labeling data reaches the second level higher than the first level through semi-supervised learning, eventually, the equipment failure diagnosis apparatus 100 may perform fully-supervised learning.

In this evolving learning process, the equipment failure diagnosis apparatus 100 may increase the amount of labeling data stored in the database 360. In addition, when a new abnormal signal is detected in the developing learning process, the equipment failure diagnosis apparatus 100 may additionally configure a new artificial intelligence network model to the artificial intelligence archive 370 and train the new artificial intelligence network model. Accordingly, the equipment failure diagnosis apparatus 100 may further deepen and develop an artificial intelligence network.

As described above, in order to determine an abnormal signal in a situation where there is no labeling data, the equipment failure diagnosis apparatus 100 may generate a virtual abnormal signal through the virtual abnormal signal generator 350. The equipment failure diagnosis apparatus 100 may store virtual abnormal signal data for the generated virtual abnormal signal in the database 360.

When the abnormal signal data is not stored in the database 360 as labeling data necessary for determining the abnormal signal (e.g., in the unsupervised learning stage), the virtual abnormal signal generator 350 may generate a virtual abnormal signal based on the normal signal data.

When the abnormal signal data for the abnormal signal less than the preset number is stored in the database 360 as labeling data necessary for determining the abnormal signal (e.g., in the semi-supervised learning stage), the virtual abnormal signal generator 350 may generate a virtual abnormal signal based on the normal signal data and labeling data.

The equipment failure diagnosis apparatus 100 may learn the artificial intelligence network using only normal signal data stored in the database 360 in the absence of labeling data, and may distinguish between a normal signal and an abnormal signal. For this operation, the equipment failure diagnosis apparatus 100 may utilize an artificial intelligence network suitable for an equipment signal, which is an acoustic signal.

Unlike image data, the acoustic signal data may include information related to time and frequency. The artificial intelligence network may be in a form in which a convolution neural network (CNN) and a long short-term memory model (LSTM) are combined in order to utilize the characteristics of the acoustic signal data.

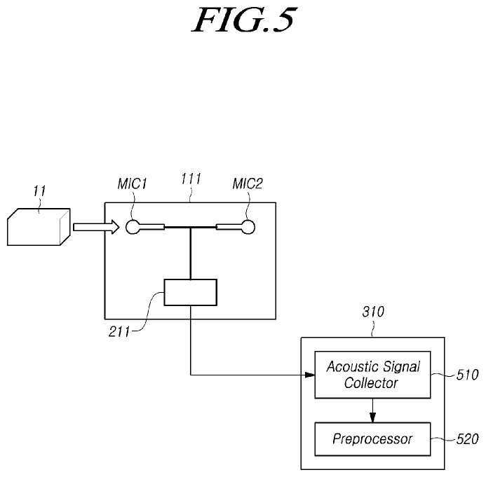

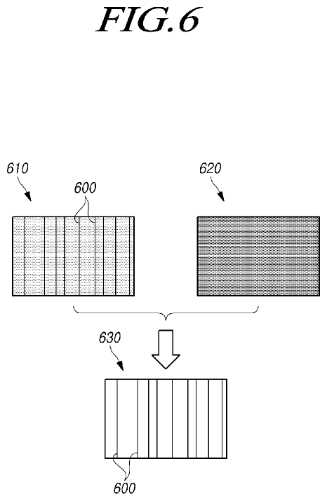

FIG. 5 is a diagram illustrating an equipment signal acquirer 310 of an equipment failure diagnosis apparatus 100 according to aspects of the present disclosure. FIG. 6 is a diagram for explaining a signal separation function of the equipment failure diagnosis apparatus 100 according to aspects of the present disclosure.

Referring to FIG. 5, the equipment signal acquirer 310 may include an acoustic signal collector 510 for collecting acoustic signals through a plurality of microphone devices MIC1 and MIC2, and a preprocessor 520 configured to compare the acoustic signals collected by the acoustic signal collector 510 to obtain an equipment signal.

A plurality of microphone devices MIC1 and MIC2 may include at least one first microphone device MIC1 installed toward the target equipment 11, and at least one second microphone device MIC2 installed toward a direction different from the first microphone device MIC1 without facing the target equipment 11.

Referring to FIGS. 5 and 6, the acoustic signal collector 510 may collect the first acoustic signal 610 through at least one first microphone device MIC1. The acoustic signal collector 510 may collect the second acoustic signal 620 through at least one second microphone device MIC2.

The first acoustic signal 610 collected through the first microphone device MIC1 may slightly include external noise generated outside the target equipment 11. However, the first acoustic signal 610 collected through the first microphone device MIC1 may further include more and more equipment signals 600 generated by the target equipment 11. The equipment signal 600 may be an acoustic signal having signal strength greater than that of external noise.

The second acoustic signal 620 collected through the second microphone device MIC2 may slightly include an equipment signal 600, which is an acoustic signal generated by the target equipment 11. However, the second acoustic signal 620 collected through the second microphone device MIC2 may include more external noise than the equipment signal 600.

Referring to FIG. 6, in each of the images showing the first acoustic signal 610 and the second acoustic signal 620, the background portion (gray portion) excluding the vertical lines corresponding to the equipment signal 600 corresponds to external noise generated from the outside of the target equipment 11.

The preprocessor 520 may perform a signal separation function of separating the equipment signal generated from the target equipment 11 and an external noise generated outside the target equipment 11.

The preprocessor 520 may obtain the equipment signal 600 generated by the target equipment 11 based on the first acoustic signal 610 and the second acoustic signal 620 as preprocessing result data 630. The preprocessor 520 may compare the first acoustic signal 610 and the second acoustic signal 620 to detect external noise that is not generated from the target equipment 11. The preprocessor 520 may obtain a pure equipment signal 600 generated from the target equipment 11 by removing external noise from the first and second acoustic signals 610 and 620.

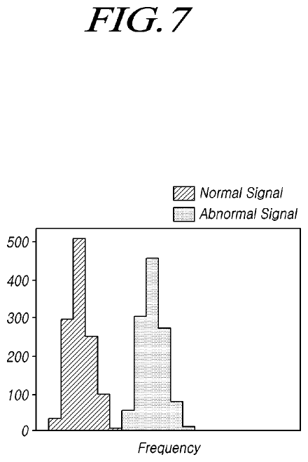

FIG. 7 is a histogram showing characteristics of a normal signal and an abnormal signal distinguished by the equipment failure diagnosis apparatus 100 according to aspects of the present disclosure.

The histogram shown in FIG. 7 shows the frequency distribution of the normal signal and the abnormal signal. The x-axis of the histogram is the frequency, and the y-axis is the number of signals.

Referring to FIG. 7, the normal signal and the abnormal signal distinguished by the equipment failure diagnosis apparatus 100 may have different frequency ranges. For example, most normal signals have a lower frequency than abnormal signals. That is, most of the abnormal signals may have a higher frequency than the normal signal.

The equipment failure diagnosis apparatus 100 may store and manage normal signal data including frequency information and/or abnormal signal data (or virtual abnormal signal data) including frequency information in the database 360 in advance.

The abnormal signal determiner 320 of the equipment failure diagnosis apparatus 100 may extract the frequency characteristic of the acquired equipment signal. The abnormal signal determiner 320 may determine whether the equipment signal having the extracted frequency characteristic is an abnormal signal by referring to the database 360.

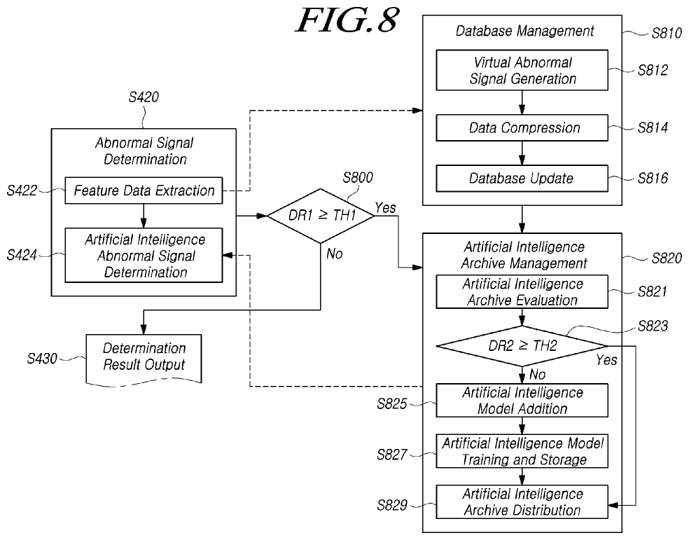

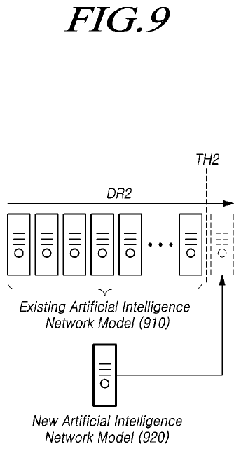

FIG. 8 is a diagram illustrating an artificial intelligence network management function of an equipment failure diagnosis apparatus 100 according to aspects of the present disclosure. FIG. 9 is a diagram conceptually illustrating an additional configuration for a new artificial intelligence network model 920 when managing an artificial intelligence network of the equipment failure diagnosis apparatus 100 according to aspects of the present disclosure.

Referring to FIG. 8, in order to perform the artificial intelligence network management function of the equipment failure diagnosis apparatus 100 according to aspects of the present disclosure, the equipment failure diagnosis process may include a database management step S810 and an artificial intelligence archive management step S820.

Referring to FIG. 8, the abnormal signal determiner 320 of the equipment failure diagnosis apparatus 100 may perform the artificial intelligence-based abnormal signal determination step S424 in connection with the database management step S810 and the artificial intelligence archive management step S820.

Referring to FIG. 8, after feature data is extracted from an equipment signal for generating a virtual abnormal signal, the database management step S810 may be performed.

The database management step S810 may include a virtual abnormal signal generation step S812, a data compression step S814, and a database update step S816. In the virtual abnormal signal generation step S812, the virtual abnormal signal generator 350 may generate a virtual abnormal signal having a high similarity to the equipment signal by using the acquired feature data of the equipment signal for generating the virtual abnormal signal. In the data compression step S814, the virtual abnormal signal generator 350 may compress virtual abnormal signal data for the generated virtual abnormal signal. In the database update step S816, the virtual abnormal signal generator 350 may store and manage the compressed data in the database 360.

The virtual abnormal signal generator 350 may generate a virtual abnormal signal having a high similarity to the existing abnormal signal data based on the virtual abnormal signal combination and consistency estimation, and expand the database 360 by using the generated virtual abnormal signal.

The virtual abnormal signal generator 350 may separate a spectrogram data for the normal signal data and the abnormal signal data, and generate virtual abnormal signal data by applying a combination of the virtual abnormal signal data to the normal signal data.

The virtual abnormal signal generator 350 may calculate a cross-correlation estimation value based on a cross-correlation between the abnormal signal data and the previously generated virtual abnormal signal data. The virtual abnormal signal generator 350 may generate virtual abnormal signal data by selecting a virtual abnormal signal combination having a maximum cross-correlation estimation value through comparison of the calculated cross-correlation estimation values.

In the equipment failure diagnosis apparatus 100 according to aspects of the present disclosure, the abnormal signal determiner 320 may extract a feature data from the equipment signal (S422). In the equipment failure diagnosis apparatus 100 according to aspects of the present disclosure, the abnormal signal determiner 320 may determine whether the equipment signal having the extracted feature data is an abnormal signal or a normal signal based on artificial intelligence (S424).

Referring to FIG. 8, the equipment failure diagnosis process according to aspects of the present disclosure may further include a first comparison step S800. The abnormal signal determiner 320 may calculate a first detection rate DR1 based on the normal signal data and the virtual abnormal signal data stored in the database 360. Here, the first detection rate DR1 may be a probability that the equipment signal having the extracted feature data is an abnormal signal. In the first comparison step S800, the abnormal signal determiner 320 may compare the calculated first detection rate DR1 with a preset first threshold value TH1.

Referring to FIG. 8, the equipment failure diagnosis process according to aspects of the present disclosure may include the determination result output step S430. If the comparison result in the first comparison step S800 is that the first detection rate DR1 is less than the first threshold value TH1, in the determination result output step S430, the abnormal signal determiner 320 may output normal determination result information indicating that the equipment signal is a normal signal, and label a data on the equipment signal as normal signal data and store the labeled data in the database 360.

Referring to FIG. 8, if the comparison result in the first comparison step S800 is that the first detection rate DR1 is greater than or equal to the first threshold value TH1, in the determination result output step S430, the abnormal signal determiner 320 may output abnormality determination result information indicating that the equipment signal is an abnormal signal based on the artificial intelligence archive 370, and label a data on the equipment signal as abnormal signal data, and store the labeled data in the database 360.

As described above, the artificial intelligence network manager 340 may store and manage the artificial intelligence archive 370. The artificial intelligence network manager 340 may interwork with the abnormal signal determiner 320 to perform an abnormal signal determination function, and perform a function of maintaining and repairing the artificial intelligence network by updating the artificial intelligence archive 370.

Referring to FIGS. 8 and 9, when the abnormal signal determiner 320 determines that the first detection rate DR1 is equal to or greater than the first threshold value TH1, the artificial intelligence network manager 340 may determine whether the equipment signal is a new type of abnormal signal by using the existing artificial intelligence network model 910 in the artificial intelligence archive 370.

When it is determined that the equipment signal is an existing type of abnormal signal, the artificial intelligence network manager 340 may control the abnormal signal determiner 320 to output abnormality determination result information indicating that the equipment signal is an abnormal signal. And the artificial intelligence network manager 340 may label data on the equipment signal as abnormal signal data and store the labeled data in the database 360. Here, the existing type is also referred to as a known type or a conventional type.

The equipment failure diagnosis process according to aspects of the present disclosure may further include an artificial intelligence model addition step S825. If it is determined that the equipment signal is a new type of abnormal signal, the artificial intelligence model addition step S825 may be executed. In the artificial intelligence model addition step S825, the artificial intelligence network manager 340 may additionally configure a new artificial intelligence network model, and update the artificial intelligence archive 370. And the artificial intelligence network manager 340 may control the abnormal signal determiner 320 to output abnormality determination result information indicating that the equipment signal is an abnormal signal. And the artificial intelligence network manager 340 may label data on the equipment signal as abnormal signal data and store the labeled data in the database 360.

Referring to FIGS. 8 and 9, the equipment failure diagnosis process according to aspects of the present disclosure may further include an artificial intelligence archive evaluation step S821 and a second comparison step S823. In the artificial intelligence archive evaluation step S821, the artificial intelligence network manager 340 may evaluate the artificial intelligence archive 370. The artificial intelligence network manager 340 may calculate a second detection rate DR2 for the equipment signal by using the existing artificial intelligence network model 910 in the artificial intelligence archive 370. In the second comparison step S823, the artificial intelligence network manager 340 may compare the calculated second detection rate DR2 with a preset second threshold TH2. Here, the second detection rate DR2 may be a probability that the equipment signal having the extracted feature data is an abnormal signal.

Referring to FIGS. 8 and 9, the equipment failure diagnosis process according to aspects of the present disclosure may further include an artificial intelligence archive distribution step S829. In the second comparison step S823, if the second detection rate DR2 is greater than or equal to the second threshold value TH2, the artificial intelligence archive distribution step S829 may be executed. If the second detection rate DR2 is greater than or equal to the second threshold TH2, the artificial intelligence network manager 340 may determine that the abnormal signal corresponding to the equipment signal is a known abnormal signal. Accordingly, by executing the artificial intelligence archive distribution step S829, the artificial intelligence network manager 340 may distribute the artificial intelligence archive 370. Further, accordingly, the abnormal signal determiner 320 may output information as a result of determination that the equipment signal is an abnormal signal of an existing type through the determination result output unit 330(S430).

Referring to FIGS. 8 and 9, if the second detection rate DR2 is less than the second threshold TH2 in the second comparison step S823, the artificial intelligence model addition step S825, the artificial intelligence model training and storage step S827, and the artificial intelligence archive distribution step S829 may be executed sequentially. If the second detection rate DR2 is less than the second threshold TH2, the artificial intelligence network manager 340 may determine that the abnormal signal corresponding to the equipment signal is a new type of abnormal signal. Accordingly, the artificial intelligence model addition step S825 is executed, and the artificial intelligence network manager 340 may additionally configure a new artificial intelligence network model 920. Thereafter, in the artificial intelligence model training and storage step S827, the artificial intelligence network manager 340 may perform learning (machine learning) on the new artificial intelligence network model 920. In addition, the artificial intelligence network manager 340 may update the artificial intelligence archive 370 so that the new artificial intelligence network model 920 is included in the artificial intelligence archive 370. Thereafter, in the artificial intelligence archive distribution step S829, the artificial intelligence network manager 340 may distribute the artificial intelligence archive 370. Accordingly, the abnormal signal determiner 320 may output information as a result of determining that the equipment signal is a new type of abnormal signal through the determination result output unit 330 (S430).

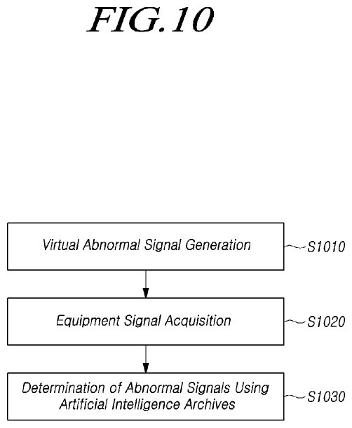

FIG. 10 is a flowchart of an equipment failure diagnosis method according to aspects of the present disclosure.

Referring to FIG. 10, the equipment failure diagnosis method of the equipment failure diagnosis apparatus 100 according to aspects of the present disclosure may include a virtual abnormal signal generation step S1010, an equipment signal acquisition step S1020, and an abnormal signal determination step S1030. In the step S1010, the equipment failure diagnosis apparatus 100 may generate a virtual abnormal signal based on the normal signal data stored in the database 360. In the step S1020, the equipment failure diagnosis apparatus 100 may obtain an equipment signal generated from the target equipment 11. In the step S1030, the equipment failure diagnosis apparatus 100 may utilize the artificial intelligence archive 370, determine whether the equipment signal is an abnormal signal based on the virtual abnormal signal, and output the determination result information.

The step S1010 may be executed when the abnormal signal data is not stored in the database 360, or abnormal signal data for abnormal signals less than a preset number is stored in the database 360.

In step S1010, the apparatus 100 for diagnosing equipment failure may generate a virtual abnormal signal based on the normal signal data. More specifically, the equipment failure diagnosis apparatus 100 may generate a signal having a frequency range different from the frequency range of the normal signal as a virtual abnormal signal.

In step S1020, the equipment failure diagnosis apparatus 100 may collect acoustic signals through a plurality of microphone devices MIC1 and MIC2. In addition, in step S1020, the equipment failure diagnosis apparatus 100 may detect external noise that does not generated in the target equipment 11 by comparing the collected acoustic signals. In addition, in step S1020, the equipment failure diagnosis apparatus 100 may obtain a signal from which external noise is removed from the collected acoustic signals as an equipment signal.

When collecting acoustic signals, the equipment failure diagnosis apparatus 100 may collect a first acoustic signal through at least one first microphone device MIC1, and collect a second acoustic signal through at least one second microphone device MIC2. The at least one first microphone device MIC1 may be installed toward the target equipment 11. The at least one second microphone device MIC2 may be installed toward a direction different from the first microphone device MIC1 without facing the target equipment 11.

In step S1030, the equipment failure diagnosis apparatus 100 may calculate a first detection rate DR1 corresponding to a probability that the equipment signal is an abnormal signal based on the normal signal data and the virtual abnormal signal data. Thereafter, the equipment failure diagnosis apparatus 100 may compare the calculated first detection rate DR1 with a preset first threshold value TH1. Thereafter, when the calculated first detection rate DR1 is less than the first threshold value TH1, the equipment failure diagnosis apparatus 100 may output normal determination result information indicating that the equipment signal is a normal signal. In addition, the equipment failure diagnosis apparatus 100 may label data on the equipment signal as normal signal data and store the labeled data in the database 360.

In step S1030, the equipment failure diagnosis apparatus 100 may calculate a first detection rate DR1 corresponding to a probability that the equipment signal is an abnormal signal based on the normal signal data and the virtual abnormal signal data. Thereafter, the equipment failure diagnosis apparatus 100 may compare the calculated first detection rate DR1 with a preset first threshold value TH1. If the calculated first detection rate DR1 is equal to or greater than the first threshold value TH1, the equipment failure diagnosis apparatus 100 may output abnormality determination result information indicating that the equipment signal is an abnormality signal based on the artificial intelligence archive 370. In addition, the equipment failure diagnosis apparatus 100 may label data on equipment signals as abnormal signal data and store the labeled data in the database 360.

In step S1030, when it is determined that the first detection rate DR1 is equal to or greater than the first threshold value TH1, the equipment failure diagnosis apparatus 100 may determine whether the equipment signal is a new type of abnormal signal by using the existing artificial intelligence network model 910 in the artificial intelligence archive 370. When it is determined that the equipment signal is an existing type of abnormal signal, the equipment failure diagnosis apparatus 100 may output abnormality determination result information indicating that the equipment signal is an abnormal signal. The equipment failure diagnosis apparatus 100 may label data on equipment signals as abnormal signal data and store the labeled data in the database 360. If it is determined that the equipment signal is a new type of abnormal signal, the equipment failure diagnosis apparatus 100 may add a new artificial intelligence network model 920 to update the artificial intelligence archive 370. The equipment failure diagnosis apparatus 100 may output abnormality determination result information indicating that the equipment signal is an abnormality signal. The equipment failure diagnosis apparatus 100 may label data on equipment signals as abnormal signal data and store the labeled data in the database 360.

The equipment failure diagnosis method according to the aspects of the present disclosure described above may be implemented as an application agent that can be stored, installed, and executed in a storage medium of a computer. Here, the computer may serve as the equipment failure diagnosis apparatus 100 by executing the application. The application agent is also referred to as an application, an application program, or a computer program.

In order to implement the method for diagnosing equipment failure according to aspects of the present disclosure, an application stored in a storage medium of a computer is executed to generate a virtual abnormal signal based on the normal signal data stored in the database 360, acquire an equipment signal generated from the target equipment 11 through at least one microphone device, determine whether the equipment signal is an abnormal signal based on the virtual abnormal signal, and output the determination result information. Here, the database 360 may be a memory device of the computer or a data structure stored in the memory device of the computer.

An application agent implementing the equipment failure diagnosis method according to aspects of the present disclosure may be installed and executed in a computer to execute the above-described functions.

In this way, the application may include code coded in a computer language such as C, C++, JAVA, and machine language that can be read by the computer's processor (CPU) through the computer's device interface.

The codes may include functional codes related to functions or the like that define the above-described functions (steps). In addition, the code may include a control code related to an execution procedure necessary for the processor of the computer to execute the above-described functions according to a predetermined procedure.

In addition, the code may further include additional information necessary for the processor of the computer to execute the above-described functions. In addition, the code may further include a code for which location (address) of the computer's internal or external memory should be referenced.

In addition, when the processor of the computer needs to communicate with any other computer or server remotely in order to execute the above-described functions, the code may further include a communication related code. For example, the communication-related code may include identification information about another computer or server to which the processor of the computer should communicate, or may include transmission/reception information.

For example, a recording medium capable of recording the above-described application program and being read by a computer includes various types of recording medium such as ROM, RAM, CD-ROM, magnetic tape, floppy disk, optical media storage device, or memory.

In addition, the computer-readable recording medium is distributed over a computer system connected through a network, so that computer-readable codes can be stored and executed in a distributed manner. In this case, any one or more computers among the plurality of distributed computers may execute some of the functions presented above, and transmit the execution result to one or more of the other distributed computers. The computer that receives the execution result may also execute some of the functions presented above and provide the result to other distributed computers as well.

In addition, in consideration of the system environment of a computer that reads the recording medium and executes the program, functional programs, related codes and code segments for implementing the present disclosure may be easily inferred or changed by programmers in the technical field to which the present disclosure belongs.

According to the aspects of the present disclosure, it is possible to provide the equipment failure diagnosis apparatus 100, the equipment failure diagnosis method, the smart factory system 10, and the application agent applicable to various industrial groups.

According to the aspects of the present disclosure, it is possible to provide the equipment failure diagnosis apparatus 100, the equipment failure diagnosis method, the smart factory system 10, and the application agent capable of diagnosing equipment failure even if there is no or insufficient labeling data necessary for determining or learning equipment failure.

According to the aspects of the present disclosure, it is possible to provide the equipment failure diagnosis apparatus 100, the equipment failure diagnosis method, the smart factory system 10, and the application agent capable of diagnosing equipment failure in a factory in a display industrial site with no or insufficient labeling data.

According to the aspects of the present disclosure, it is possible to provide the equipment failure diagnosis apparatus 100, the equipment failure diagnosis method, the smart factory system 10, and the application agent capable of accurately diagnosing equipment failure while building a database using the virtual abnormal signal generated by generating a virtual abnormal signal in a situation where labeling data is not present or insufficient.

According to the aspects of the present disclosure, it is possible to provide the equipment failure diagnosis apparatus 100, the equipment failure diagnosis method, the smart factory system 10, and the application agent capable of quickly and accurately diagnosing equipment failure based on an acoustic signal.

According to the aspects of the present disclosure, it is possible to provide the equipment failure diagnosis apparatus 100, the equipment failure diagnosis method, the smart factory system 10, and the application agent capable of developing an artificial intelligence network model based on virtual abnormal signal generation when developing an artificial intelligence network model through unlabeled data.

According to the aspects of the present disclosure, it is possible to provide the equipment failure diagnosis apparatus 100, the equipment failure diagnosis method, the smart factory system 10, and the application agent having an acoustic collection environment robust to noise so that accurate equipment failure diagnosis is possible based on an acoustic signal.

According to the aspects of the present disclosure, it is possible to provide the equipment failure diagnosis apparatus 100, the equipment failure diagnosis method, the smart factory system 10, and the application agent capable of performing management functions such as maintenance of an artificial intelligence network.

The above description has been presented to enable any person skilled in the art to make and use the technical idea of the present disclosure, and has been provided in the context of a particular application and its requirements. Various modifications, additions and substitutions to the described aspects will be readily apparent to those skilled in the art, and the general principles defined herein may be applied to other aspects and applications without departing from the spirit and scope of the present disclosure. The above description and the accompanying drawings provide an example of the technical idea of the present disclosure for illustrative purposes only. That is, the disclosed aspects are intended to illustrate the scope of the technical idea of the present disclosure. Thus, the scope of the present disclosure is not limited to the aspects shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. An equipment failure diagnosis apparatus comprising:
a virtual abnormal signal generator configured to generate a virtual abnormal signal based on a normal signal data stored in a database, and to store a virtual abnormal signal data for the virtual abnormal signal in the database;
an equipment signal acquirer configured to obtain an equipment signal generated from a target equipment; and
an abnormal signal determiner configured to determine whether the equipment signal is an abnormal signal based on the virtual abnormal signal data, and to output determination result information.

2. The equipment failure diagnosis apparatus according to claim 1, wherein the equipment signal acquirer comprises:
an acoustic signal collector for collecting acoustic signals through a plurality of microphone devices; and
a preprocessor for obtaining the equipment signal by comparing the acoustic signals collected by the acoustic signal collector.

3. The equipment failure diagnosis apparatus according to claim 2, wherein the plurality of microphone devices comprises at least one first microphone device installed toward the target equipment, and at least one second microphone device installed toward a direction different from the first microphone device without facing the target equipment,
wherein the acoustic signal collector is configured to collect a first acoustic signal through the at least one first microphone device, and to collect a second acoustic signal through the at least one second microphone device, and
wherein the preprocessor is configured to obtain the equipment signal by removing external noise that does not occur in the target equipment based on a result of comparing the first acoustic signal and the second acoustic signal.

4. The equipment failure diagnosis apparatus according to claim 1, wherein the virtual abnormal signal generator is configured to generate the virtual abnormal signal based on the normal signal data when an abnormal signal data is not stored in the database as labeling data for determining the abnormal signal, and
wherein the virtual abnormal signal generator is configured to generate the virtual abnormal signal based on the normal signal data and the abnormal signal data when the abnormal signal data for abnormal signals less than a preset number is stored in the database as labeling data for determining the abnormal signal.

5. The equipment failure diagnosis apparatus according to claim 1, wherein the virtual abnormal signal generator is configured to generate, as the virtual abnormal signal, a signal having a frequency range different from a frequency range of the normal signal.

6. The equipment failure diagnosis apparatus according to claim 1, wherein the virtual abnormal signal generator is configured to remove external noise from the equipment signal for generating the virtual abnormal signal and generate the remaining signal as the virtual abnormal signal.

7. The equipment failure diagnosis apparatus according to claim 1, wherein the abnormal signal determiner is configured to calculate first detection rate corresponding to a probability that the equipment signal is an abnormal signal based on the normal signal data and the virtual abnormal signal data;
wherein the abnormal signal determiner is configured to compare the first detection rate with a first threshold value;
wherein when the first detection rate is less than the first threshold value, the abnormal signal determiner is configured to:
output a normal determination result information indicating that the equipment signal is a normal signal,
label a data on the equipment signal as normal signal data, and
store the data labeled as the normal signal data in the database; and
wherein, when the first detection rate is equal to or greater than the first threshold value, the abnormal signal determiner is configured to:
output an abnormality determination result information indicating that the equipment signal is an abnormal signal based on an artificial intelligence archive,
label a data on the equipment signal as abnormal signal data, and
store the data labeled as the abnormal signal data in the database.

8. The equipment failure diagnosis apparatus according to claim 7, further comprising an artificial intelligence network manager for storing and managing the artificial intelligence archive,
wherein, when it is determined by the abnormal signal determiner that the first detection rate is equal to or greater than the first threshold value, the artificial intelligence network manager is configured to determine whether the equipment signal is a new type of abnormal signal using an existing artificial intelligence network model in the artificial intelligence archive;
wherein, when it is determined that the equipment signal is an abnormal signal of an existing type, the artificial intelligence network manager is configured to:
control the abnormal signal determiner to output the abnormality determination result information indicating that the equipment signal is an abnormal signal,
label the data on the equipment signal as abnormal signal data, and
store the data labeled as the abnormal signal data in the database; and
wherein when it is determined that the equipment signal is a new type of abnormal signal, the artificial intelligence network manager is configured to:
add a new artificial intelligence network model to update the artificial intelligence archive,
control the abnormal signal determiner to output the abnormality determination result information indicating that the equipment signal is an abnormal signal,
label the data on the equipment signal as abnormal signal data, and
store the data labeled as abnormal signal data in the database.

9. The equipment failure diagnosis apparatus according to claim 8, wherein the artificial intelligence network manager is configured to calculate a second detection rate for the equipment signal by using the existing artificial intelligence network model in the artificial intelligence archive;
wherein the artificial intelligence network manager is configured to compare the second detection rate with a preset second threshold value;
wherein when the second detection rate is equal to or greater than the second threshold value, the artificial intelligence network manager is configured to determine that an abnormal signal corresponding to the equipment signal is a known abnormal signal; and
wherein when the second detection rate is less than the second threshold value, the artificial intelligence network manager is configured to:
determine that the abnormal signal corresponding to the equipment signal is a new type of abnormal signal,
additionally configure a new artificial intelligence network model,
perform machine learning on the new artificial intelligence network model, and
update the artificial intelligence archive so that the new artificial intelligence network model is included in the artificial intelligence archive.

10. The equipment failure diagnosis apparatus according to claim 1, wherein the target equipment is equipment for manufacturing a display panel, and the equipment signal is an acoustic signal generated from the target equipment.

11. An equipment failure diagnosis method comprising:
generating a virtual abnormal signal based on a normal signal data stored in a database;
obtaining an equipment signal generated from a target equipment; and
determining whether the equipment signal is an abnormal signal based on the virtual abnormal signal, and outputting determination result information.

12. The equipment failure diagnostic method according to claim 11, wherein the obtaining of the equipment signal comprises:
collecting acoustic signals through a plurality of microphone devices; and
comparing the collected acoustic signals to detect external noise that does not occur in the target equipment, and removing the external noise from the collected acoustic signals to obtain the equipment signal.

13. The equipment failure diagnostic method according to claim 12, wherein the collecting of the acoustic signals comprises:
collecting a first acoustic signal through at least one first microphone device installed toward the target equipment; and
collecting a second acoustic signal through at least one second microphone device installed toward a different direction from the first microphone device.

14. The equipment failure diagnostic method according to claim 11, wherein the generating of the virtual abnormal signal is executed when an abnormal signal data is not stored in the database or an abnormal signal data for less than a specific number of abnormal signals is stored in the database.

15. The equipment failure diagnostic method according to claim 11, wherein the operation of generating the virtual abnormal signal is the operation of generating a signal having a frequency range different from a frequency range of the normal signal as the virtual abnormal signal.

16. The equipment failure diagnostic method according to claim 11, the determining whether the equipment signal is the abnormal signal comprises:
calculating first detection rate corresponding to a probability that the equipment signal is an abnormal signal based on the normal signal data and the virtual abnormal signal data;
comparing the first detection rate with a first threshold value;
when the first detection rate is less than the first threshold value, outputting a normal determination result information indicating that the equipment signal is a normal signal, labeling a data on the equipment signal as normal signal data, and storing the data labeled as the normal signal data in the database; and
when the first detection rate is equal to or greater than the first threshold value, outputting an abnormality determination result information indicating that the equipment signal is an abnormal signal based on an artificial intelligence archive, labeling a data on the equipment signal as abnormal signal data, and storing the data labeled as the abnormal signal data in the database.

17. An application agent stored and executed in a storage medium in a computer in order to execute a method for diagnosing equipment failure, the method comprising:
generating a virtual abnormal signal based on a normal signal data stored in a database;
obtaining an equipment signal generated from a target equipment through at least one microphone device; and
determining whether the equipment signal is an abnormal signal based on the virtual abnormal signal, and outputting determination result information.

18. A smart factory system comprising:
a first sensor installed around a first equipment and configured to sense and output acoustic signals;
a second sensor installed around a second equipment and configured to sense and output acoustic signals; and
an equipment failure diagnosis apparatus configured to diagnose whether each of the first equipment and the second equipment has a failure,
wherein the equipment failure diagnosis apparatus is configured to:
extract a first equipment signal generated by the first equipment from the acoustic signal output from the first sensor,
extract a second equipment signal generated by the second equipment from the acoustic signal output from the second sensor,
determine whether each of the first equipment signal and the second equipment signal is an abnormal signal by referring to an artificial intelligence network model in an artificial intelligence archive, and database, and output the determination result information, and
add a new artificial intelligence network model to the artificial intelligence archive, or label a data for each of the first equipment signal and the second equipment signal as normal signal data or abnormal signal data and store the labeled data in the database.

19. The smart factory system according to claim 18, wherein the first sensor includes at least one first microphone device installed toward the first equipment, and at least one second microphone device installed toward a different direction from the first microphone device without facing the first equipment, and
wherein the second sensor includes at least one third microphone device installed toward the second equipment, and at least one fourth microphone device installed toward a direction different from the first microphone device without facing the second equipment.

20. The smart factory system according to claim 18, wherein the equipment failure diagnosis apparatus includes an Internet of Things (IoT) communication module for IoT-based networking with the first sensor and the second sensor.
